(19) United States
(12) Patent Application Publication
(10) Pub. No.: US 2019/0316678 A1
(43) Pub. Date: Oct. 17, 2019

(54) Fully-Floating Pivot Joint With Press-Fit Bushings

(71) Applicant: Ford Global Technologies, LLC, Dearborn, MI (US)

(72) Inventor: Richard Werth, Milan, MI (US)

(73) Assignee: Ford Global Technologies, LLC, Dearborn, MI (US)

(21) Appl. No.: 15/951,964

(22) Filed: Apr. 12, 2018

(51) Int. Cl. F16J 1/16; F16J 1/22; F16C 9/04; F16C 17/03

(52) U.S. Cl. CPC F16J 1/16; F16J 1/22; F16C 23/043; F16C 17/035; F16C 9/04

(57) ABSTRACT

A pivot joint is disclosed that has an inner link with an opening and an outer link with two spaced-apart tabs that each have openings. The opening of the inner link has an inner bushing press-fit therein. A pivot pin is inserted through the aligned openings of the inner link and the outer link. The pivot pin has two outer bushings press fit on either end. By press fitting the bushings on, the pivot pin is trapped in place. By trapping the pivot pin, it can be a fully-floating pin that yields lower friction and wear and/or supports higher loads. The press fit outer bushings supplant the prior-art practice of placing a circlip at the ends of the outer bushings to keep them from sliding out. The disclosed pivot joint is more compact and lighter weight than the prior art pivot joint that uses clips.

### FIELD

The present disclosure relates to a pivot joint that fully floats, in particular one without clips.

### BACKGROUND

Pivot joints, such as those found between a piston and the connecting rod can be fixed, semi-floating, or fully-floating. A fully-floating joint has the lowest friction, wears more evenly, and/or carries more load. A fully-floating pivot joint typically includes clips or snap rings to hold the pin in place.

In FIG. 1, a piston-connecting rod joint 10 is shown. A piston 12 is connected to a small end of a connecting rod 14 via a piston pin 16 (also called a wrist pin). Piston pin 16 is held into place via snap rings 18 that snap into grooves defined in bores 20 in bosses of piston 12.

In some pivot joints, the space taken up by the snap ring cannot be accommodated. A compact, fully-floating pivot joint that obviates a snap ring is desired.

### SUMMARY

To overcome at least one problem in the prior art a pivot joint is disclosed that has: an inner link having an opening; an outer link having two spaced-apart tabs each having an opening; a pivot pin inserted through the three openings; an inner bushing disposed between the pivot pin and the inner link; and two outer bushings press fit on either end of the pivot pin between the pivot pin and the outer link. The inner bushing is press fit to the inner link. Bushing, as used herein, are alternatively called sleeve bearings or plain bearings.

An end of the inner link with the opening is disposed in a slot formed between the two tabs of the outer link. The opening of the inner link is aligned with the two openings in the tabs of the outer links.

A first of the two outer bushings is press fit onto the pivot pin prior to inserting the pivot pin through the three openings. A second of the two outer bushings is press fit onto the pivot pin after inserting the pivot pin through the three openings.

The first outer bushing is press fit onto the pivot pin by one of: an interference fit and raising temperature of the bushing with respect to the pivot pin prior to coupling the bushing with the pivot pin.

The pivot pin is inserted through the inner bushing at the time of insertion through the three openings.

The inner bushing abuts the outer bushings.

A length of the pivot pin is substantially the same as a distance between an outer surface of a first of the two tabs of the outer link to an outer surface of a second of the two tabs of the outer link.

In some embodiments, the pivot joint is a piston to connecting rod joint, that includes: a connecting rod having a small end with an opening, a piston having two bosses separated by a slot, each boss having an opening, a wrist pin inserted through the openings in the piston and connecting rod, an inner bushing disposed between the connecting rod and the wrist pin, and an outer bushing press fit on each end of the wrist pin. The inner bushing and connecting rod have a press fit connection.

A first of the two outer bushings is press fit onto the wrist pin prior to inserting the wrist pin through the three openings. A second of the two outer bushings is press fit onto the wrist pin after inserting the wrist pin through the three openings.

The outer bushings are press fit onto the wrist pin by an interference fit in some embodiments. In other embodiments, the temperature of the bushing is raised with respect to the wrist pin by heating the bushing and/or cooling the wrist pin prior to coupling the bushing with the wrist pin.

The wrist pin is inserted through the inner bushing at the time of insertion through the three openings.

A length of the wrist pin is substantially the same as the distance between an outer surface of a first of the two piston bosses to an outer surface of a second of the two piston bosses.

Also disclosed is a pivot joint with an inner link having an opening; a pivot pin with an outer bushing press fit on one end, an outer link having two spaced-apart tabs each having an opening, an inner bushing placed in the opening of the inner link, and a pivot pin inserted through the two outer link openings and the inner bushing.

The outer bushing is press fit onto the pivot pin prior to the pivot pin being inserted through the two outer link openings and the inner bushing.

The pivot joint also has an outer bushing press fit onto an end of the pivot pin opposite the one end. The outer bushing on the opposite end is press fit onto the pivot pin after the pivot pin is inserted in the two outer link openings.

The outer bushings are press fit onto the pivot pin by an interference fit or by raising the temperature of the bushing with respect to the pivot pin prior to coupling the bushing with the pivot pin.

According to various aspects of the disclosure, the pivot joint is narrower than the prior art joint that uses clips. In some applications, the narrower joint facilitates compact designs. The narrower joint uses less material, is lighter, and leads to less rocking imbalance.

### BRIEF DESCRIPTION OF THE DRAWINGS

FIG. 1 is an illustration of a prior-art, fully-floating piston-to-connecting rod pivot joint;

FIG. 2 shows a prior-art pivot joint;

FIG. 3 shows a prior-art pivot joint in cross section;

FIG. 4 shows a pivot joint according to embodiments of the present disclosure;

FIG. 5 shows a cross-sectional view of a pivot joint according to embodiments of the present disclosure; and

FIG. 6 is a flowchart of one embodiment showing processes undertaken to assemble such a pivot joint of FIGS. 4 and 5.

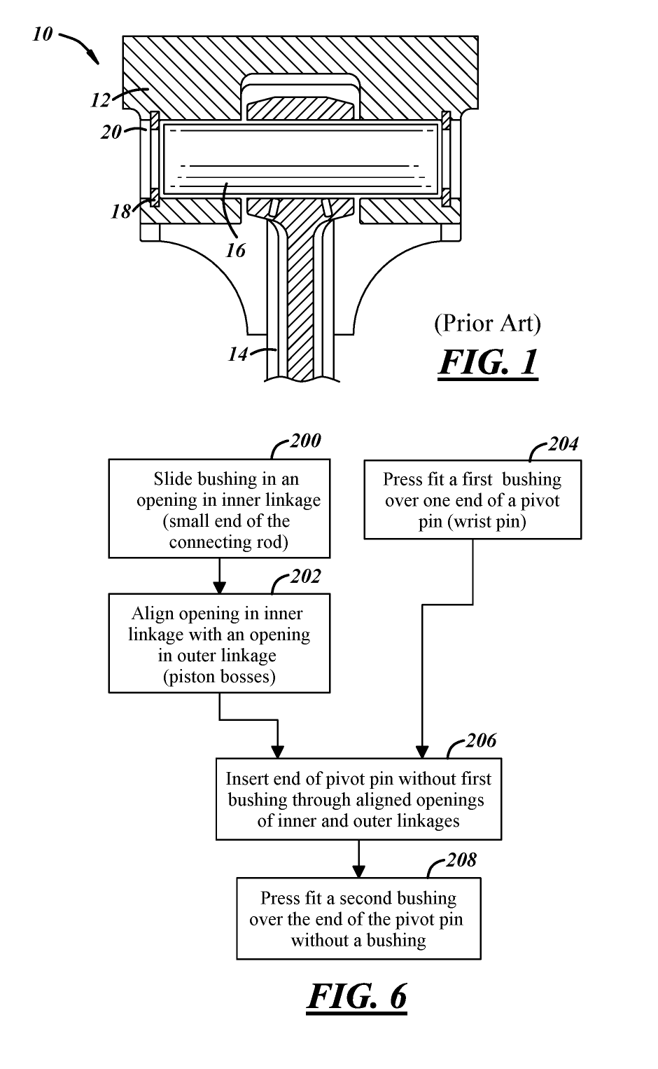

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

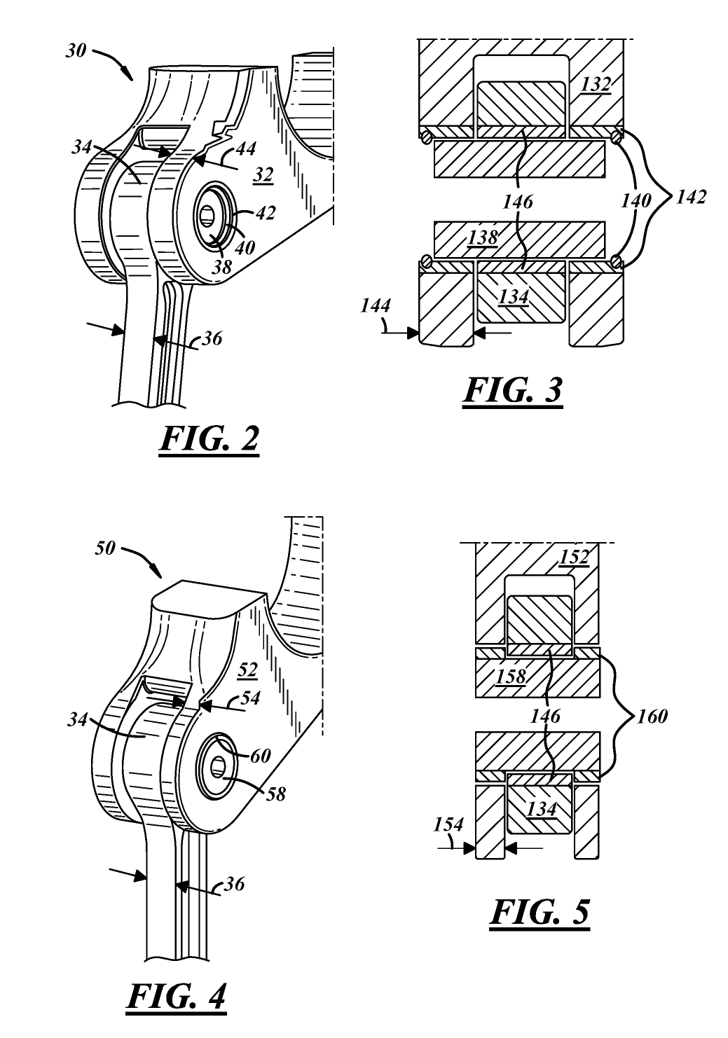

In FIG. 2, a prior-art pivot joint 30 has an inner link 34 coupled to an outer link 32 via a pivot pin 38. If this is the joint in an internal combustion engine, the inner link is the connecting rod (small end), the pivot pin is a wrist pin or gudgeon pin, and the outer link is a piston, specifically the piston bosses for the wrist pin. A bushing 42 is held in place by a retaining clip 40. Such retaining clip would also be shown on the other end of pivot pin 40. A cross section of such a joint 130 is shown in FIG. 3 in which a pivot pin 138 is inserted through openings in inner link 134 and outer link 132. Bushings are provided between the linkages and pivot pin 138. A pair of bushings 142 are provided between outer link 132 and ends of pivot pin 138. A single bushing 146 is provided between inner link 134 and pivot pin 138. To retain bushings 142 in place, a clip 140 is provided at each end of the joint.

In FIG. 4, a pivot joint 50 has the inner link 34 coupled to an outer link 52 via a pivot pin 58. A bushing 60 is provided between outer link and pivot pin 58. In FIG. 5, a pivot joint 150 has an outer link 152 coupled to the inner link 134 via a pivot pin 158. A pair of bushings 160 are provided on the ends of pivot pin 158 that separate pivot pin 158 from outer link 154. A bushing 146 is provided between pivot pin 158 and inner link 134.

Referring to FIGS. 2 and 4, inner link 34 is the same in each and has the same width 36. However, outer links, 32 in FIG. 2 and 152 in FIG. 4, are different. Outer link has the same gap to accommodate inner link 34. However, outer link 52 has narrower portions through which pivot pin 58 extends, as shown by dimension 54 than the comparable dimension 44 of outer link 32 of FIG. 2.

Similarly, in FIGS. 3 and 5, prior art joint 130 shows an outer link width of 144 where pivot pin extends as opposed to narrower 154 in FIG. 4. As can be seen in FIG. 3, the reason for the width 144 is to accommodate clips 140. The overall width of prior-art joint 130 is wider than joint 150 of FIG. 5. In some applications, narrower part is crucial for compact packaging. In all cases, the lesser mass results in lower material costs, overall weight of the assembly, and less shaking forces during operation.

In FIG. 4, outer link 52 has two tabs 60, each having an opening to accommodate pivot pin 58. Tabs 60 are displaced from each other to form a slot into which inner link 34 is disposed. In piston-to-connecting rod applications, the outer link is the piston and the tabs are bosses in the piston.

To allow pin 158, of FIG. 5, to be fully floating and maintain it in place, bushings 160 are press fit onto pivot pin 158. Thus, pin 158 is trapped by axial contact between bushings 146 and 160. An assembly flowchart is shown in FIG. 6. In block 200, a bushing is press fit into the opening in the inner link (134 of FIG. 5). This inner link, in some applications, is the small end of a connecting rod. In block 202 the opening in the inner link is aligned with the one of two openings in outer link (152 of FIG. 5). In the embodiment in which the inner link is a connecting rod, the part of the outer link through which the pivot pin is inserted are bosses on a piston. In block 204, a first bushing is press fit over one end of the pivot pin. This may be accomplished with an interference fit, by heating the bushing, cooling the pivot pin, or any suitable way to accomplish a press fit. In block 206, the pivot pin is inserted through the aligned openings of the inner and outer links. This is accomplished by inserting the end of the pivot pin that does not have a bushing on it into the opening. The press fit bushing on the pivot pin is bumped up against the bushing (146 from FIG. 5). In block 208, the second bushing is press fit onto the end of the pivot pin that does not have a bushing. This press fit is accomplished in situ on the assembly. Alternatively, both outer bushings (160 of FIG. 5) can be press fit onto the pivot after the pivot pin is inserted through the openings in the inner and outer links.

Bushings 160 and 146 of FIG. 5 are not fully floating. Pin 158 is fully floating and kept in place via contact between bushings 160 and 146.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, recyclability, environmental factors, manufacturability, ease of assembly, etc. The embodiments described herein that are characterized as less desirable than other embodiments or prior art implementations with respect to one or more characteristics are not outside the scope of the disclosure and may be desirable for particular applications.

We claim:

1. A pivot joint, comprising:
an inner link having an opening;
an outer link having two spaced-apart tabs each having an opening;
a pivot pin inserted through the three openings;
an inner bushing disposed between the pivot pin and the inner link; and
two outer bushings press fit on either end of the pivot pin between the pivot pin and the outer link.

2. The pivot joint of claim 1 wherein:
an end of the inner link with the opening is disposed in a slot formed between the two tabs of the outer link;
the inner bushing and inner link are coupled via press fit; and
the opening of the inner link is aligned with the two openings in the tabs of the outer links.

3. The pivot joint of claim 1 wherein a first of the two outer bushings is press fit onto the pivot pin prior to inserting the pivot pin through the three openings.

4. The pivot joint of claim 3 wherein a second of the two outer bushings is press fit onto the pivot pin after inserting the pivot pin through the three openings.

5. The pivot joint of claim 3 wherein the first outer bushing is press fit onto the pivot pin by one of: an interference fit and raising temperature of the bushing with respect to the pivot pin prior to coupling the bushing with the pivot pin.

6. The pivot joint of claim 1 wherein the pivot pin is inserted through the inner bushing at the time of insertion through the three openings.

7. The pivot joint of claim 1 wherein the inner bushing abuts the outer bushings.

8. The pivot joint of claim 1 wherein a length of the pivot pin is substantially the same as a distance between an outer surface of a first of the two tabs of the outer link to an outer surface of a second of the two tabs of the outer link.

9. A piston to connecting rod joint, comprising:
a connecting rod having a small end with an opening;
a piston having two bosses separated by a slot, each boss having an opening;
a wrist pin inserted through the openings in the piston and connecting rod;
an inner bushing disposed between the connecting rod and the wrist pin; and
an outer bushing press fit on each end of the wrist pin.

10. The joint of claim 9 wherein:
a first of the two outer bushings is press fit onto the wrist pin prior to inserting the wrist pin through the three openings;
the inner bushing is press fit into the connecting rod; and
a second of the two outer bushings is press fit onto the wrist pin after inserting the wrist pin through the three openings.

11. The joint of claim 9 wherein the outer bushings are press fit onto the wrist pin by one of: an interference fit and raising temperature of the bushing with respect to the wrist pin prior to coupling the bushing with the wrist pin.

12. The joint of claim 9 wherein the wrist pin is inserted through the inner bushing at the time of insertion through the three openings.

13. The joint of claim 9 wherein a length of the wrist pin is substantially the same as the distance between an outer surface of a first of the two piston bosses to an outer surface of a second of the two piston bosses.

14. A pivot joint, comprising:
an inner link having an opening;
a pivot pin with an outer bushing press fit on one end;
an outer link having two spaced-apart tabs each having an opening;
an inner bushing placed in the opening of the inner link; and
a pivot pin inserted through the two outer link openings and the inner bushing.

15. The pivot joint of claim 14 wherein the outer bushing is press fit onto the pivot pin prior to the pivot pin being inserted through the two outer link openings and the inner bushing.

16. The pivot joint of claim 14, further comprising:
an outer bushing press fit onto an end of the pivot pin opposite the one end wherein the outer bushing on the opposite end is press fit onto the pivot pin after the pivot pin is inserted in the two outer link openings.

17. The pivot joint of claim 16 wherein the inner bushing is immediately adjacent to the outer bushings.

18. The joint of claim 16 wherein the outer bushings are press fit onto the pivot pin by one of: an interference fit and raising temperature of the bushing with respect to the pivot pin prior to coupling the bushing with the pivot pin.

19. The joint of claim 14 wherein:
a length of the pivot pin is substantially the same as a distance between an outer surface of a first of the two tabs of the outer link to an outer surface of a second of the two tabs of the outer link.
